(19) United States
(12) Patent Application Publication
(10) Pub. No.: US 2007/0134460 A1
(43) Pub. Date: Jun. 14, 2007

(54) Universal sticker

(76) Inventors: Han-Chin Chen, Tainan City (TW); Chia-Hua Chen, Rende Hsiang (TW)

Correspondence Address: Han-Chin CHEN, P.O. BOX 90, Tainan City, 70499, TW

(21) Appl. No.: 11/302,237

(22) Filed: Dec. 14, 2005

(51) Int. Cl. B32B 33/00

(52) U.S. Cl. 428/40.1; 428/137; 428/100

(57) ABSTRACT

A universal sticker includes two soft rubber magnets respectively having an upper end tightly connected together; a hook fixed on a front surface of the front one of the two magnets; and a peel-pap. The rear magnet has a layer of glue coated on its rear surface with a peel-paper adhered on the layer of glue. In using, the universal sticker is directly placed and attracted magnetically on a surface of a metal object, or adhered on a nonmetal object by first removing the peel-paper and then letting the layer of glue adhere on the nonmetal object, If a sheet of paper is to be clamped by the sticker, the front magnet is first swung up and then the paper is placed on the rear magnet and the front magnet is pushed back to superpose and clamp the paper therebetween. The hook can hang a trinket or the like.

### BACKGROUND OF THE INVENTION

1. Field of the Invention

This invention relates to a universal sticker, particularly to one provided with two soft rubber magnets having different polarities from each other and an upper end closely connected with each other. Further, a front one of the two soft magnets is provided with a hook on its front surface and a peel-paper is adhered on a layer of glue on the rear surface of the rear soft magnet. In using, the sticker can be directly placed and attracted magnetically on a surface of a metal object or the peel-paper is peeled off and the sticker can be adhered on a surface of a non-metal object by means of the layer of glue on the rear surface of the rear soft magnet. In case the sticker placed on something is used for clamping a paper on the surface of something, first the front soft magnet is swung up relative to the rear soft magnet, and then a paper is placed on the front surface of the rear soft magnet and then the front soft magnet is swung down back to superpose on the rear soft magnet, with the paper sandwiched stably. Further the hook can keep a trinket or the like thereon.

2. Description of the Prior Art

Conventional stickers or universal stickers are provided with a layer of glue on an upper end of its rear side of a paper so that the stickers can adhere on an object such as a billboard or the like, after the paper is written with memos. Or they can be adhered on a location very conspicuous. But conventional stickers are not of good adhesiveness, liable to fall off. Further, there are conventional magnetic stickers to magnetically placing a paper on a metal surface, not usable for non-metal objects.

### SUMMARY OF THE INVENTION

The purpose of the invention is to offer a universal sticker possible to magnetically and stably attract and stay on a surface of a metal object or to be adhered on a surface of a non-metal object for conveniently clamping a paper therebetween.

The feature of the invention is two soft rubber magnets respectively bored with a hole in an upper portion for a linking member to pass through for linking together the two soft magnets. Further, the rear soft magnet has a layer of glue on the rear surface and a peel-paper adhered on the layer of glue.

Another feature of the invention is two soft rubber magnets with an upper end fixed with each other, so the front magnet has a linking section with two slits so as to be lifted up for placing a paper on the rear magnet and then the front magnet is pushed down back to clamp the paper therebetween.

### BRIEF DESCRIPTION OF DRAWINGS

This invention will be better understood by referring the accompanying drawings, wherein:

FIG. 1 is an exploded perspective view of a first embodiment of a universal sticker in the present invention;

FIG. 2 is a perspective view of the first embodiment of a universal sticker in the present invention;

FIG. 3 is a side view of the first embodiment of a universal sticker in the present invention;

FIG. 4 is a side view of the first embodiment of a universal sticker in the present invention, shown it in a using condition;

FIG. 5 is a side view of the first embodiment of a universal sticker in the present invention, showing it in another using condition;

FIG. 6 is a perspective view of the first embodiment of a universal sticker in the present invention, showing it used for clamping a paper;

FIG. 7 is a perspective view of the first embodiment of a universal sticker in the present invention, showing it used in clamping a paper;

FIG. 8 is a perspective view of the first embodiment of a universal sticker in the present invention, showing it used on a surface of a metal;

FIG. 9 is a perspective view of a second embodiment of a universal sticker in the present invention;

FIG. 10 is a perspective view of the second embodiment of a universal sticker in the present invention, showing it being used in clamping a paper;

FIG. 11 is a perspective view of the second embodiment of a universal sticker in the present invention; showing it used to clamp a paper; and,

FIG. 12 is a perspective view of the universal sticker in the present invention, showing it used for hanging an object.

### DETAILED DESCRIPTION OF THE PREFERRED EMBODIMENT

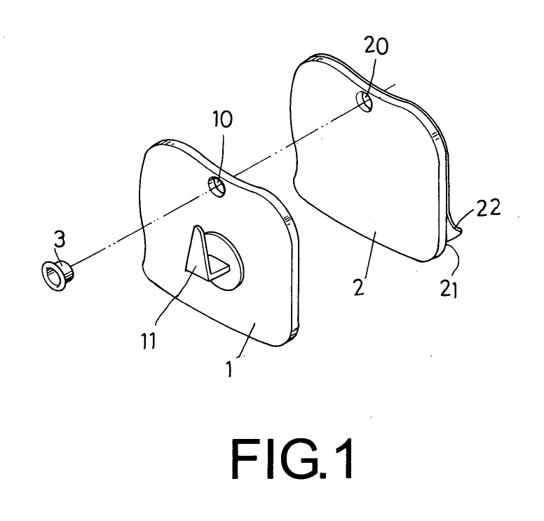

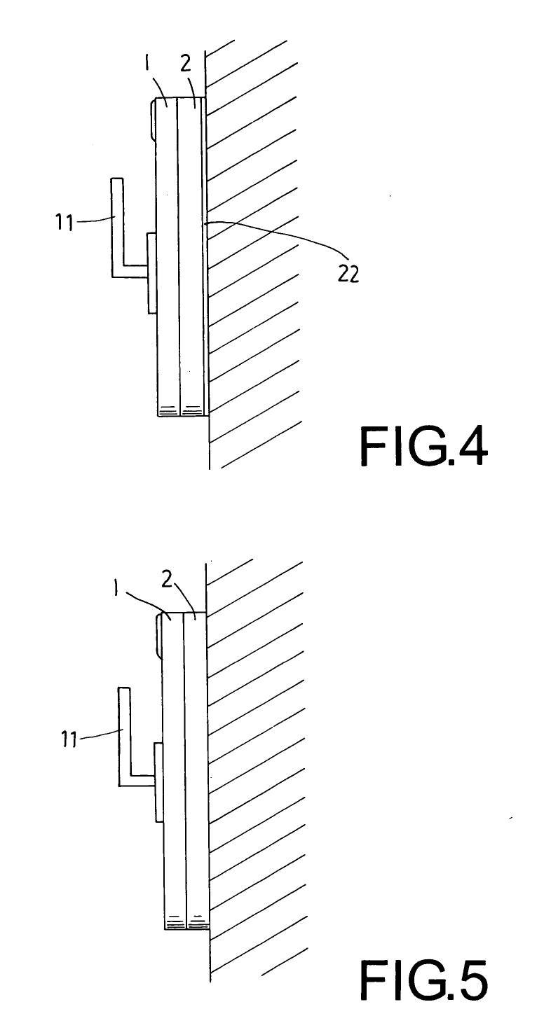

A first embodiment of a universal sticker in the present invention, as shown in FIGS. 1, 2 and 3, includes two soft rubber magnets 1 and 2 provided with different polarities from each other and a hole 10, 20 respectively, a hook 11 fixed on a front surface of the first soft rubber magnet 1, a layer of glue 21 coated on a rear surface of the second soft rubber magnet 2, a peel-paper 22 adhered on the layer of glue 21, and a linking member 3 fitting in the holes 10 and 20 of the two soft rubber magnets 1 and 2. The linking member 3 may be a rivet.

In assembling, the rivet 3 is fitted in the holes 10 and 20 of the two magnets 1 and 2, combining the two magnets stably together.

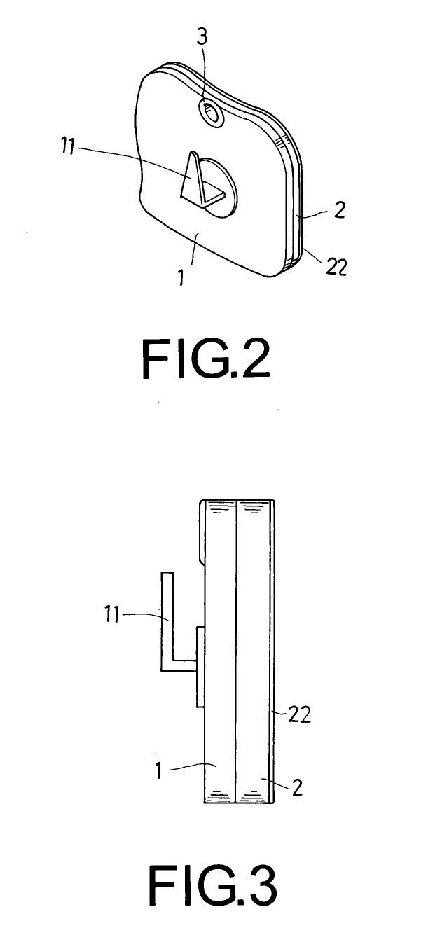

In using, referring to FIGS. 2 to 5, the sticker can be placed and attracted magnetically on the surface of a metal object such as the door of a refrigerator, a metal billboard, etc. Or the sticker can be adhered on a surface of a nonmetal object having no magnetic attraction property, by removing the peel-paper 22 off the rear surface of the second magnet 2 and letting the layer of glue 21 adhere on the surface of a nonmetal object.

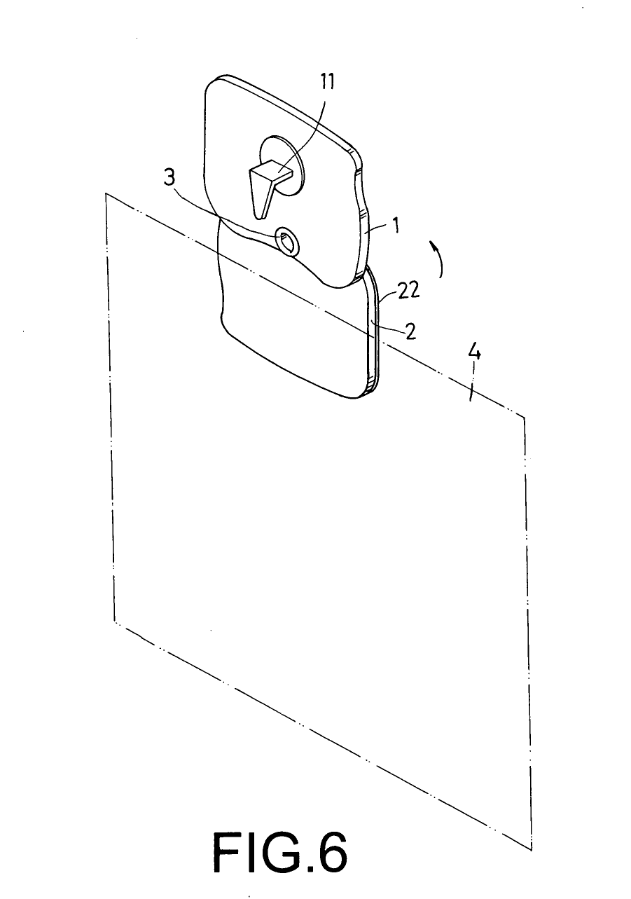

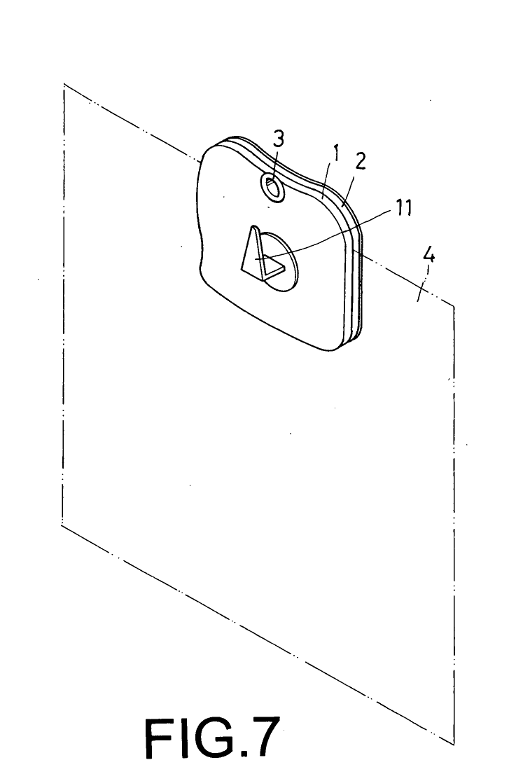

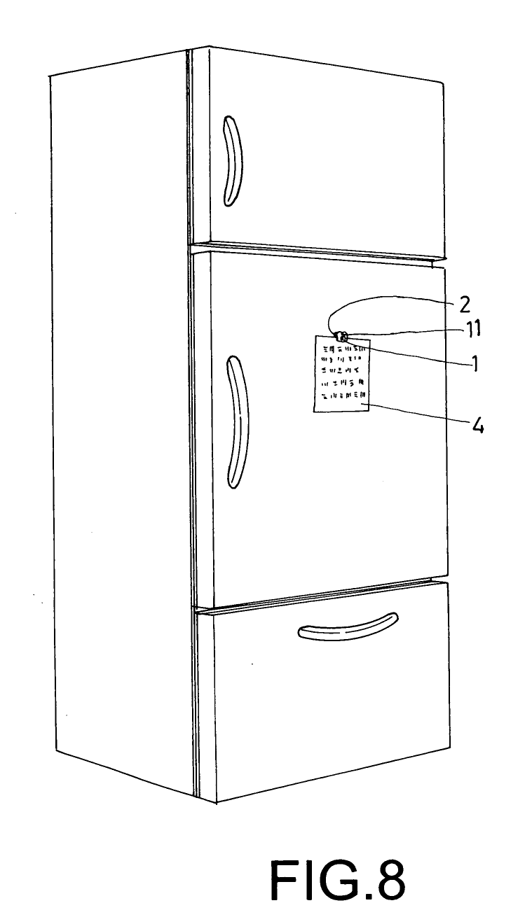

Next, if the sticker is used for clamping a paper after placed on a surface of an object, referring to FIGS. 6, 7 and 8, the first magnet 1 is swung up for an angle, preferably 90 degrees with the rivet 3 functioning as a pivot, and then a sheet of paper is put on the second magnet 2 properly. Then the first magnet 1 is swung down back to superpose the second magnet 2, clamping stably the paper 4 therebetween.

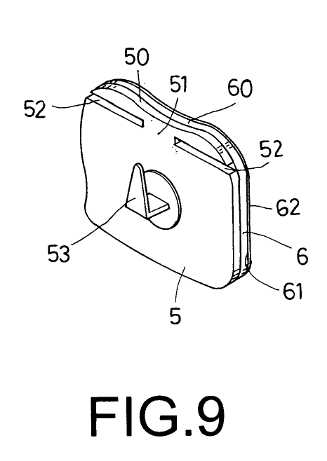

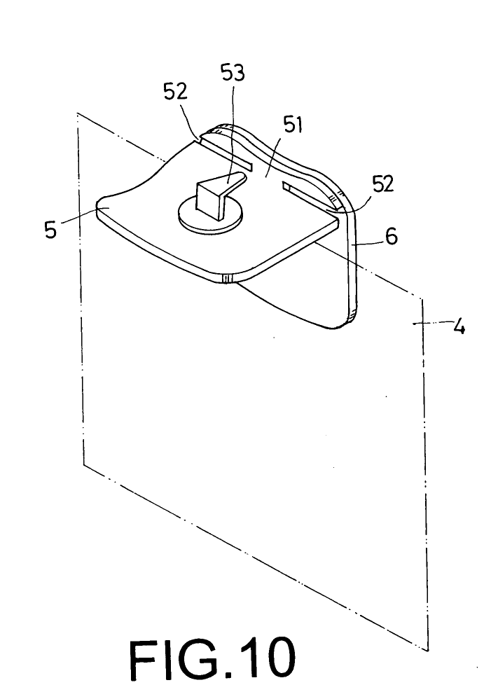

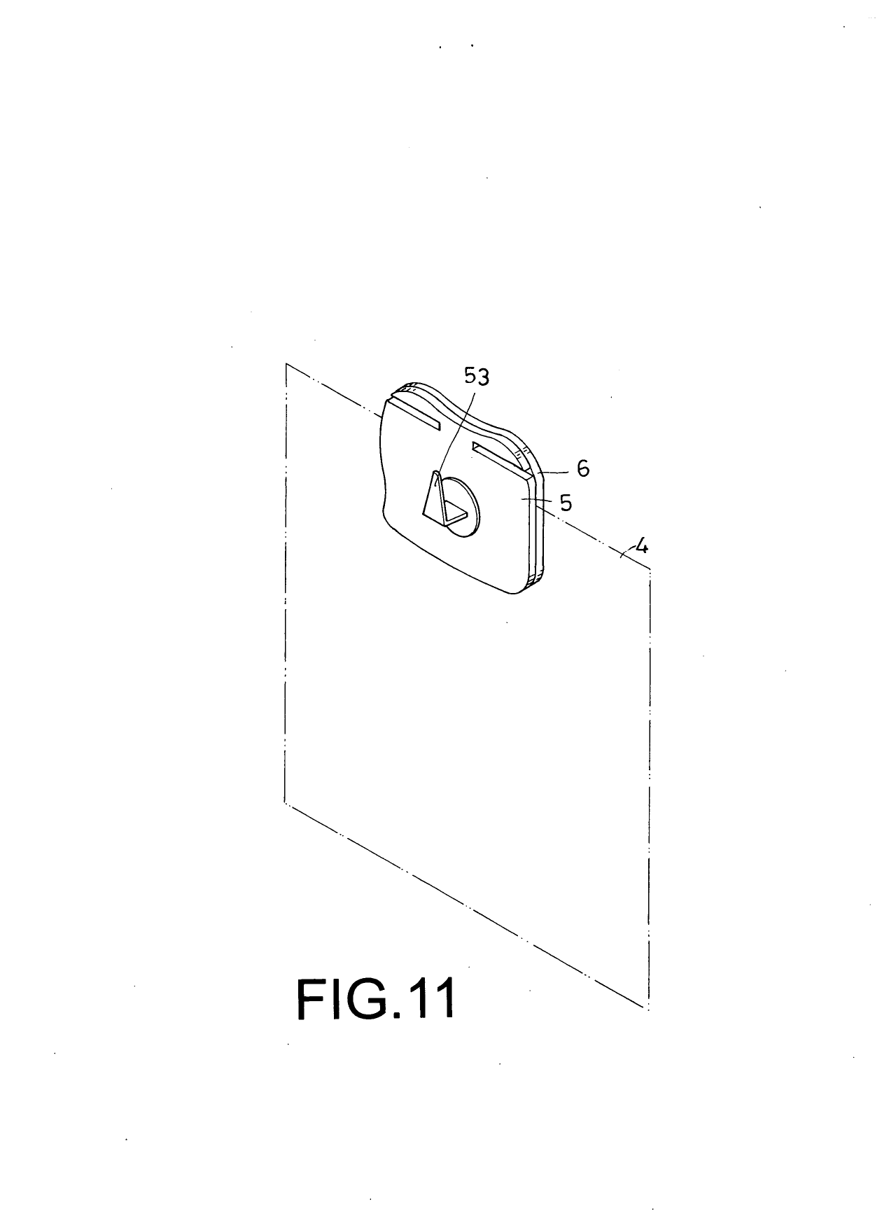

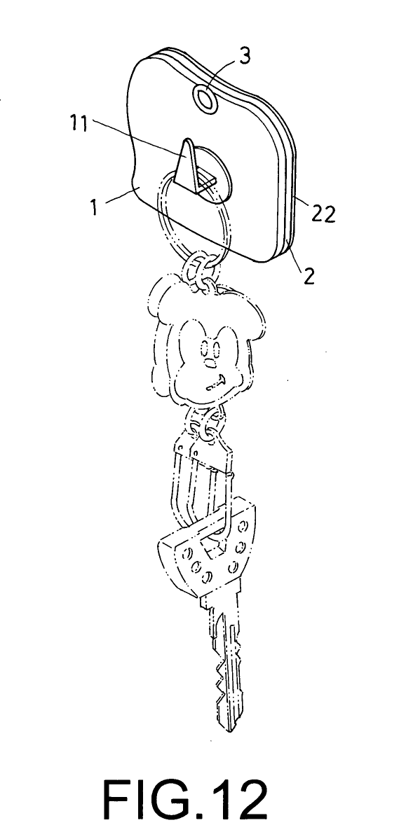

Next, FIGS. 9, 10 and 11 show a second embodiment of a universal sticker in the invention, which includes two soft rubber magnets 5 and 6, two upper ends 50 and 60 of the two magnets 5 and 6 connected with each other, a linking section 51 formed in an upper section of the first magnet 5 and having a slit 52 respectively in two opposite sides, a hook 53 fixed on a front surface of the first magnet 5, a layer of glue 61 coated on the rear surface of the second magnet 2 and a peel-paper 62 adhered on the layer of glue 61.

In using the second embodiment of a universal sticker, it can be directly placed and attracted magnetically on a surface of a metal object such as a door of a refrigerator, a metal billboard or the like. Or it can be adhered on a surface of a nonmetal object with no magnetic attraction property, by removing the peel-paper 62 and letting the layer of glue 61 adhered on the surface of the nonmetal object.

If the second embodiment of a universal sticker is placed stably on the surface of an object, and a sheet of paper 4 is to be clamped by it, the first magnet 5 is lifted upward, the paper 4 is placed on the second magnet 6, and the first magnet 5 is pushed down to cover on the paper 4 placed on the second magnet 6, clamping stably the paper 4 therebetween.

Generally speaking, the universal sticker in the invention can not only be used to be placed and attracted magnetically on a surface of a metal object for clamping a sheet of paper for looking at any time, but also can hook something such as a trinket, rubber rings, a key ring or the like on the hook 11 (53), very convenient for use.

While the preferred embodiments of the invention have been described above, it will be recognized and understood that various modifications may be made therein and the appended claims are intended to cover all such modifications that may fall within the spirit and scope of the invention.

1. A universal sticker comprising two soft rubber magnets 1, 2, said magnets respectively provided with a hole 10, 20 at upper end thereof, a rear one of said magnets having its rear surface coated with a layer of glue 21, a peel-paper 22 adhered on said layer of glue on said rear surface of said rear magnet, and a linking member 3 fitting in said holes of said two magnets; and
wherein the two rubber magnets are capable of contacting to one another.

2. The universal sticker as claimed in claim 1, wherein said linking member is a rivet 3.

3. The universal sticker comprising two soft rubber magnets 5, 6, said two magnets having an upper end 50, 60 fixed with each other and in contact to each other, a front one of said two magnets 5, 6 provided with a linking section 51 formed in an upper portion, said linking section 51 having two slits 52 respectively in two opposite sides, a rear one of said two magnets 5, 6 coated with a layer of glue on a rear surface, and a peel-paper 62 adhered on said layer of glue on the rear surface of said rear magnet; and
wherein each slit 52 has an open end at an edge of the front magnet 50.

4. The universal sticker as claimed in claim 1, wherein said front magnet has a hook 11 fixed on its front surface.

5. The universal sticker as claimed in claim 3, wherein said front magnet has a hook 53 fixed on its front surface.
